(19) United States
(12) Patent Application Publication
(10) Pub. No.: US 2016/0119924 A1
(43) Pub. Date: Apr. 28, 2016

(54) MITIGATION OF PERIODIC INTERFERENCE IN A WIRELESS LOCAL AREA NETWORK

(71) Applicant: Telefonaktiebolaget L M Ericsson (publ), Stockholm (SE)

(72) Inventors: Bengt Lindoff, Bjarred (SE); Leif Wilhelmsson, Dalby (SE)

(21) Appl. No.: 14/520,555

(22) Filed: Oct. 22, 2014

(51) Int. Cl. H04W 72/04; H04W 72/12; H04W 16/14

(52) U.S. Cl. CPC H04W 72/0453; H04W 16/14; H04W 72/12; H04W 88/08

(57) ABSTRACT

A wireless access point device that schedules packet transmission and reception by a set of devices in a wireless local area network is operated. The set of devices includes the access point device and one or more other devices. Operation involves detecting the presence of periodic transmissions on a first carrier frequency from a first transmitter not operating in the wireless local area network, wherein one or more future occurrences of the periodic transmissions will interfere with reception of a packet by a first device of the set of devices. Packet transmission and reception are scheduled within the wireless local area network such that the first device performs packet transmission and no reception during the one or more future occurrences of the detected periodic transmissions.

### BACKGROUND

The invention relates to wireless communications, more particularly to wireless local area networks, and still more particularly to the operation of wireless local area networks in the presence of periodic interference.

Many portions of the radiofrequency spectrum are designated unlicensed bands, and these bands are presently widely used by wireless local area network (WLAN) technology. Because they are unlicensed, these bands are free for use by any device, so interference avoidance and/or tolerance are considerations in the design of such technology.

WLAN technology that complies with IEEE 802.11 standards is known as “Wi-Fi” technology. A Wi-Fi deployment involves a so-called access point (AP) to which some number of so-called “stations” (STA) can wirelessly connect. Wi-Fi technology operates in an unlicensed band, and the sharing of this spectrum is achieved by dividing the total bandwidth into a number of channels. The channels are typically 20 MHz wide in the 2.4 GHz band, where up to 13 channels are defined. These channels partially overlap one another, and thus will interfere with one another. Typically, three non-overlapping channels are used in the 2.4 GHz band. For the 5 GHz band, which has a much larger available bandwidth, many more channels are available. However, with the development of the IEEE 802.11n and IEEE 802.11ac standards, the bandwidth of the channels has been increased from 20 MHz to 40, 80, and even 160 MHz. Thus, the number of non-overlapping channels is still rather small, particularly when the wider bandwidths are used.

In typical WLAN deployments involving more than one AP, channels are allocated in a manner that attempts to avoid having one AP's channel overlap those of another. In practice, this often means that one tries to maximize the distance between APs using the same channel, so that the transmissions of one will not interfere with the transmissions of another. The strategy adopted for channel access is Carrier Sense Multiple Access with Collision Avoidance (CSMA/CA), in which the channel is first sensed to detect its possible use by one or more other transmitters. Transmission is initiated only if the sensing results in the channel being declared Idle. If the channel is instead declared Busy, the transmission is essentially deferred until the channel is found Idle.

When the range of several APs using the same frequency is sufficiently large, the coverage areas of the APs will overlap. Combined with the use of CSMA/CA, this means that all transmissions related to one AP will be deferred whenever a transmission on the same frequency to or from another AP that is within range is detected. Effectively, this means that if several APs are within range, they will have to share the channel in time, and the throughput for the individual APs may be severely degraded.

Cellular communication networks also employ wireless technology, and these have historically utilized licensed rather than unlicensed bands. However, discussions have recently started relating to the use of the unlicensed bands by one such network, the so-called Long Term Evolution (LTE) network that is standardized by the Third Generation Partnership Project (3GPP). One approach involves the LTE network operating on a best effort basis by using the unlicensed band as carrier aggregation of a secondary cell (SCell) while operating a Primary cell (PCell) in licensed spectrum. Thus, the network's connection to the device will still be maintained via at least the PCell even if interference by, for example, Wi-Fi or other technology (e.g., Bluetooth®) prevents communication on the SCell.

The present discussions are focusing on the SCell being used only for down-link (DL) communications, thus requiring the use of a PCell for up-link (UL) communications. However, it can be envisioned that, in the future, there may be LTE (or other) systems operating in the ISM band without the need for a simultaneous link in a licensed band. Such a system would most likely use time division duplex (TDD) to achieve shared usage of channels. Additionally, one of the more important goals in the evolvement of the IEEE 802.11 standard is to increase the spectrum efficiency in very dense deployments. This development work is done within the IEEE 802.11ax task group (TG). As one option for the 802.11ax standard, the use of a more scheduled approach has been discussed; that is, one in which channel access is controlled by the AP, rather than distributed. Thus, it is possible that there may be future 802.11-compliant technology whose operation is based on TDD.

In order to ease the description and avoid the use of the cumbersome generic terms “WLAN-type” and “LTE-type”, as used herein the term “WLAN” is used generically to cover all types of ad hoc local area networking technology, such as and without limitation, Wi-Fi (i.e., IEEE 802.11 compatible) technology and Bluetooth® (i.e., Bluetooth SIG-defined) technology. Similarly, references to LTE should be construed broadly to cover any type of other network having relevant characteristics similar to the proposed LTE systems described herein (e.g., the use of the unlicensed band without conforming to WLAN standards for ad hoc local area networking, and transmissions having a predictable periodic nature).

The inventors have recognized that the situation involving concurrent use of the unlicensed band by different types of systems (e.g., concurrently by WLAN and LTE systems) can cause problems for the WLAN system. For example, if another system, (e.g. an LTE system as defined by 3GPP standards) is used in the same band as the WLAN network, this use may severely degrade performance within the WLAN network if no counteraction is taken. In particular, because of the CSMA/CA mechanism, the WLAN system may defer a transmission upon sensing that the spectrum is Busy, and this may happen even if the signal quality (e.g., the signal-to-interference-ratio (SIR)) for performing the transmission would have been sufficient to allow that transmission to be successful. In addition, there is a high likelihood that an ongoing WLAN transmission will experience interference from an LTE transmission because the channel access in WLAN is typically based on distributed access, (e.g., using the distributed coordination function (DCF), which is a mechanism whereby each potential user of the spectrum that is presently sensed as “Busy” applies an algorithm to decide how long to defer its next transmission attempt).

In scenarios in which an LTE (TDD) node operates on a channel that is the same, adjacent to, or even further away from one used by a WLAN deployment, the LTE transmission may cause severe interference for the WLAN system. The interference caused by the LTE transmission can manifest itself in very different ways. If the LTE system is using the unlicensed band only as a secondary cell, then only DL transmissions will cause interference. However, whether the DL causes most interference to the AP (WLAN UL) or to the STA (WLAN DL) will depend on the location of the different devices. For this reason it is very difficult to determine how well for instance an LTE system and a WLAN deployment will coexist. If the LTE system is also using the unlicensed band for its UL transmission, there are even more possible interference scenarios. In this case the different UEs using LTE may cause interference to both the AP and to different STAs. If a UE is close to the AP, the LTE UL transmission may severely degrade reception at the AP, whereas if the UE is far from the AP but close to a STA, the LTE UL transmission may instead interfere with reception at the STA. Regardless of whether the LTE system is using the unlicensed band for UL transmissions, its DL transmissions can pose problems if it is using frequencies that are at or close to the ones used by the WLAN deployment.

It is therefore desired to have technology that can mitigate or avoid the potential degradation of WLAN performance that can result from periodic interference such as but not limited to interference from an LTE TDD system operating in or near the same band and/or channel as the WLAN deployment.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof. Also, as used herein the term “exemplary” means serving as one illustration out of any number of possible illustrations.

In accordance with one aspect of the present invention, the foregoing and other objects are achieved in technology for operating a wireless access point device that schedules packet transmission and reception by a set of devices in a wireless local area network, wherein the set of devices includes the access point device and one or more other devices. Such operation includes detecting the presence of periodic transmissions on a first carrier frequency from a first transmitter not operating in the wireless local area network, wherein one or more future occurrences of the periodic transmissions will interfere with reception of a packet by a first device of the set of devices. Packet transmission and reception within the wireless local area network are scheduled such that the first device performs packet transmission and no reception during the one or more future occurrences of the detected periodic transmissions.

In some but not necessarily all embodiments, the wireless local area network operates in an unlicensed band of a radio frequency spectrum, and the first carrier frequency is a neighboring carrier frequency of the unlicensed band.

In some but not necessarily all embodiments, the first transmitter is a transmitter operating in a cellular communication system, the wireless local area network operates in an unlicensed band of a radio frequency spectrum, and the periodic transmissions on the first carrier frequency are licensed assisted transmissions in the unlicensed band of the radio frequency spectrum by the first transmitter.

In some but not necessarily all embodiments, the first transmitter is a transmitter operating in a cellular communication system, the periodic transmissions on the first carrier frequency are time division duplex uplink or downlink transmissions of the first transmitter; and detecting the presence of periodic transmissions on the first carrier frequency comprises communicating information from a node of the cellular communication system to the wireless access point device.

In some but not necessarily all embodiments, the first transmitter is a transmitter operating in a cellular communication system, the periodic transmissions on the first carrier frequency are time division duplex uplink or downlink transmissions of the first transmitter, and detecting the presence of periodic transmissions on the first carrier frequency comprises the wireless access point device performing a cell scan and identifying radio access technology associated with neighboring carriers.

In some but not necessarily all embodiments, the first device uses the first carrier frequency to receive the packet. In some but not necessarily all other embodiments, the first device uses a second carrier frequency to receive the packet, and the second carrier frequency is adjacent to the first carrier frequency.

In some but not necessarily all embodiments, the wireless local area network operates in a first frequency band of a radio frequency spectrum, and the first carrier frequency is in a second frequency band that is adjacent to the first frequency band.

In some but not necessarily all embodiments, scheduling packet transmission and reception within the wireless local area network such that the first device performs packet transmission and no reception during the one or more future occurrences of the detected periodic transmissions comprises establishing one or more contention free periods for medium access within the wireless local area network.

In some but not necessarily all embodiments, operation includes ascertaining that the one or more future occurrences of the periodic transmissions will not interfere with reception of a packet by a second device of the set of devices, and scheduling packet transmission and reception within the wireless local area network such that the second device performs reception during the one or more future occurrences of the detected periodic transmissions. In some but not necessarily all such embodiments, the second device is configured to use any one of a plurality of modulation and coding schemes providing respective levels of robustness of communication, and operation comprises preventing the second device from using any one of the modulation and coding schemes that does not provide a level of robustness that is higher than a threshold level of robustness.

In some but not necessarily all embodiments, scheduling packet transmission and reception within the wireless local area network is, in part, based on a data rate and delivery time requirement of packet transmissions to the first device and further on the data rate and delivery time requirements of one or more other devices in the wireless local area network such that devices having time critical data at a low data rate receive data during the one or more future occurrences of the detected periodic transmissions, and such that other ones of the devices having less time critical data at a higher data rate receive data during future non-occurrences of the detected periodic transmissions.

In some but not necessarily all embodiments, operation includes ascertaining that one or more future occurrences of the periodic transmissions will interfere with reception of a packet by a second device of the set of devices, and scheduling packet transmission and reception within the wireless local area network such that the second device performs packet transmission and no reception during the one or more future occurrences of the detected periodic transmissions.

### BRIEF DESCRIPTION OF THE DRAWINGS

The objects and advantages of the invention will be understood by reading the following detailed description in conjunction with the drawings in which:

FIG. 1 illustrates an exemplary WLAN deployment having a WLAN coverage area that is controlled by an AP.

FIG. 2 illustrates another exemplary WLAN deployment having a WLAN coverage area that is controlled by an AP.

FIG. 3 illustrates a periodic interference pattern experienced by an AP of a WLAN.

FIG. 4 illustrates a modified periodic interference pattern resulting from scheduling in accordance with an aspect of embodiments consistent with the invention.

FIG. 5 is, in one respect, a flow chart of steps/processes performed by circuitry in accordance with some but not necessarily all exemplary embodiments of the invention.

FIG. 6 is a block diagram of an exemplary access point of a WLAN.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of non-transitory computer/processor readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

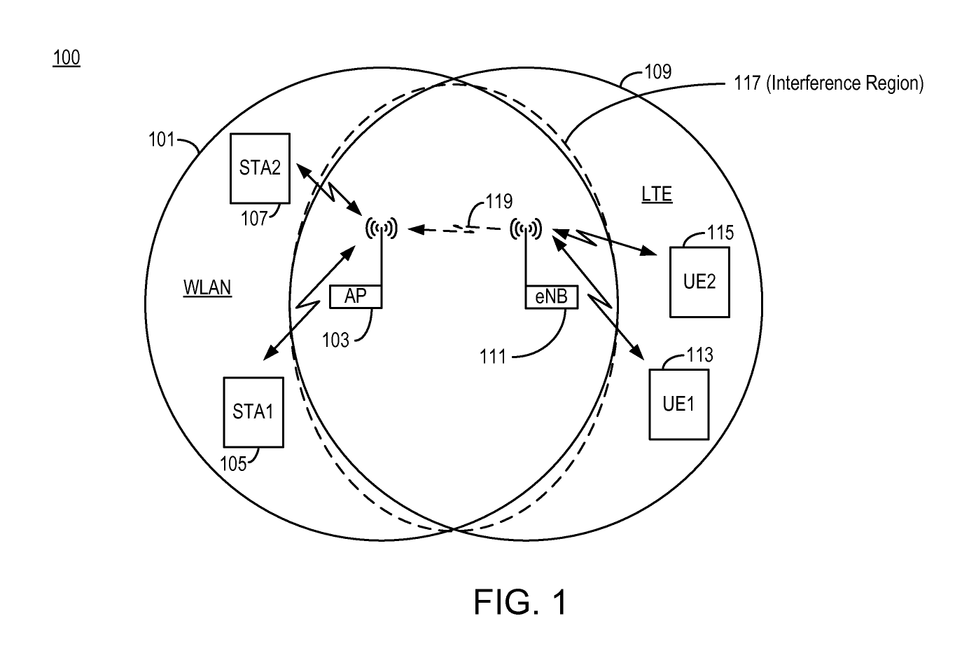

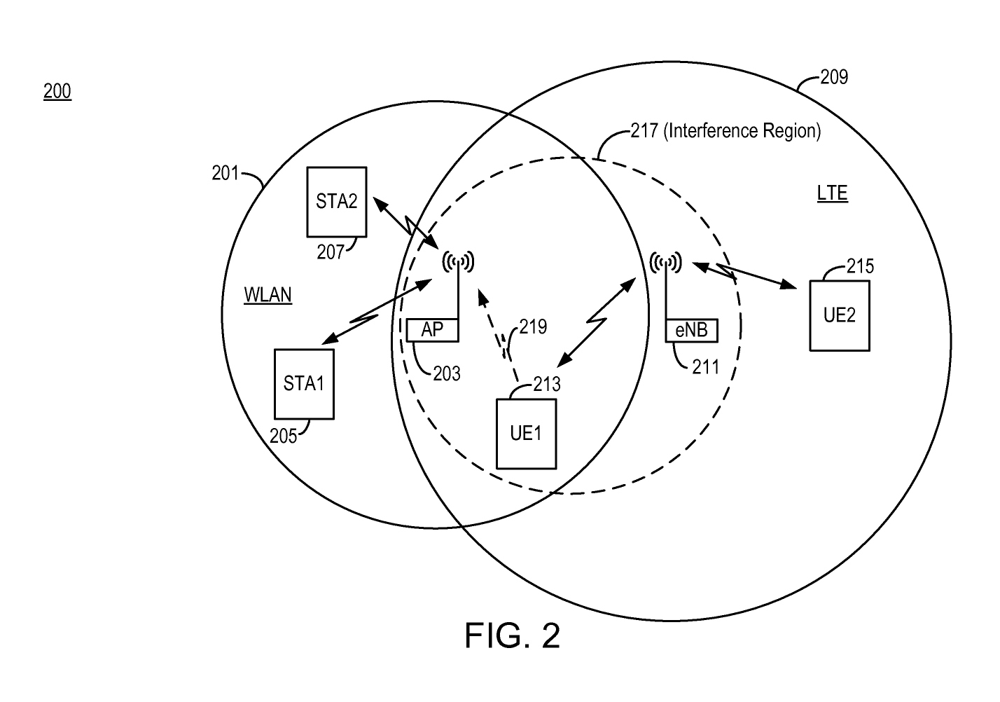

An LTE system's DL and UL transmissions in the vicinity of a WLAN deployment can cause interference problems for the WLAN's AP and/or stations, depending on the transmit power and proximity of the LTE system's transmitter. FIGS. 1 and 2 illustrate possible interference scenarios. Looking first at FIG. 1, this illustrates an exemplary WLAN deployment having a WLAN coverage area 101 that is controlled by an AP 103. In this example, the AP 103 communicates with a first station 105 and a second station 107. The functionality of the AP 103 is different from that of the other devices (in this example, the first and second stations 105, 107) in that it serves as the stations' gateway to a data network and in some cases can take a controlling role with respect to communications within the WLAN. But all are devices of some type and all engage in wireless communication in one or more unlicensed bands. Consequently, the AP 103 and the first and second stations 105, 107 together constitute a set of devices in this exemplary WLAN deployment. It will be understood that other deployments would still have an AP, but could have a different number of stations. The WLAN deployment is nearby an LTE coverage area 109 that is served by an eNB 111 operating in the same unlicensed band as the AP 103 (e.g., ISM band at 5 GHz) or near the AP's band of operation (e.g., AP 103 operating in ISM band at 2.4 GHz and eNB 111 operating in LTE Band 40), in the DL direction, and in some instances also the UL direction. The eNB 111 transmits on a channel that is the same as, or adjacent to, the channel used by the AP 103. The figure is not drawn to scale with respect to the relative sizes of the WLAN coverage area 101 and the size of the LTE coverage area 109. In practice, the size of the LTE coverage area 109 would ordinarily be larger than the size of the WLAN coverage area 101 (e.g., an LTE coverage area can extend anywhere from 10 m to 100 km in radius compared to WLAN's approximately 30 m range).

For purposes of illustration, first and second UEs 113 and 115, both served by the eNB 111, are shown. It will be understood that the eNB 111 may additionally be serving other UEs (not shown).

In this example the WLAN coverage area 101 and the LTE coverage area 109 partially overlap, so that any device operating within this region would be within range of both the AP 103 and the eNB 111. The eNB's DL transmissions, being in or near the unlicensed band, therefore create an interference region 117 (shown in dashed lines for clarity). Of note in this example is the presence of both the AP 103 and the eNB 111 within the interference region 117. As a consequence of this proximity, the eNB's DL transmissions 119 (indicated by dashed lines) unintentionally reaching the AP 103 can interfere with the AP's ability to receive one or more packets when, in one instance, the LTE system and WLAN deployment are both operating in, for example, the 5 GHz unlicensed ISM band (e.g., with the LTE system employing carrier aggregation, such as for licensed assisted LTE access) in the unlicensed 5 GHz ISM band. In another instance, this same arrangement 100 can also result in the LTE system's DL transmission causing interference at the WLAN AP when the WLAN deployment is operating in the 2.4 GHz unlicensed ISM band (2.4-2.483 GHz) and the LTE system is operating in the well-defined LTE Band 40 using TDD (TDD-LTE at 2.3-2.4 GHz).

Unlike the AP 103, the first and second stations 105, 107 are situated outside of the interference region 117 and so are not disturbed by the eNB's DL transmissions—they are able to receive the DL transmissions from the AP 103 without interference from the eNB 111.

It is further noted that the first and second UEs 113, 115 are far from any of the devices of the WLAN deployment, so their UL transmissions will not cause any interference in that deployment.

FIG. 2 shows another interference scenario arrangement 200, this one illustrating an instance in which an LTE UE's UL transmission interferes with the AP reception. More particularly, FIG. 2 illustrates an exemplary WLAN deployment having a WLAN coverage area 201 that is controlled by an AP 203. In this example, the AP 203 communicates with a first station 205 and a second station 207. As before, the functionality of the AP 203 is different from that of the other devices (in this example, the first and second stations 205, 207) in that it serves as the stations' gateway to a data network and in some cases can take a controlling role with respect to communications within the WLAN. But all are devices of some type and all engage in wireless communication in one or more unlicensed bands. Consequently, the AP 203 and the first and second stations 205, 207 together constitute a set of devices in this exemplary WLAN deployment. It will be understood that other deployments would still have an AP, but could have a different number of stations. The WLAN deployment is nearby an LTE coverage area 209 that is served by an eNB 211 operating in the same unlicensed band as the AP 203 (e.g., 5 GHz ISM band) or near the AP's band of operation (e.g., AP 203 operating in 2.4 GHz ISM band and eNB 211 operating in LTE Band 40), in the DL direction, and in this instance also the UL direction. The figure is not drawn to scale with respect to the relative sizes of the WLAN coverage area 201 and the size of the LTE coverage area 209. In practice, the size of the LTE coverage area 209 would ordinarily be larger than the size of the WLAN coverage area 201 (e.g., an LTE coverage area can extend anywhere from 10 m to 100 km in radius compared to WLAN's approximately 30 m range).

For purposes of illustration, first and second UEs 213 and 215, both served by the eNB 211, are shown. It will be understood that the eNB 211 may additionally be serving other UEs (not shown). The first and second UEs 213, 215 transmit on a channel that is the same as, or adjacent to, the channel used by the AP 203.

In this example the WLAN coverage area 201 and the LTE coverage area 209 partially overlap, so that any device operating within this region would be within range of both the AP 203 and the eNB 211. The first UE's UL transmissions, being in or near the unlicensed band, therefore create an interference region 217 (shown in dashed lines for clarity). Of note in this example is the presence of the AP 203 within the first UE's interference region 217. As a consequence of this proximity, the first UE's UL transmissions 219 (indicated by dashed lines) unintentionally reaching the AP 203 can interfere with the AP's ability to receive one or more packets when, in one instance, the LTE system and WLAN deployment are both operating in, for example, the 5 GHz unlicensed ISM band (e.g., with the LTE system employing carrier aggregation (e.g., for licensed assisted LTE access) in the unlicensed 5 GHz ISM band. In another instance, this same arrangement 200 can also result in the LTE system's DL transmission causing interference at the WLAN AP when the WLAN deployment is operating in the 2.4 GHz unlicensed ISM band (2.4-2.483 GHz) and the LTE system is operating in the well-defined LTE Band 40 using TDD (TDD-LTE at 2.3-2.4 GHz).

Unlike the AP 203, the first and second stations 205, 207 are situated outside of the interference region 217 and so are not disturbed by the first UE's UL transmissions—they are able to receive the DL transmissions from the AP 203 without interference from the first UE 213.

It is further noted that the second UE 215 is far from any of the devices of the WLAN deployment, so its UL transmissions will not cause any interference in that deployment.

In one aspect of embodiments consistent with the invention, mitigating periodic interference of the type described above involves synchronizing the affected device's transmission timing to line up with the frame structure of the periodic interference (e.g., in the case of 3GPP LTE, the LTE frame structure).

In another aspect, the periodic interference is detected by the AP autonomously. Alternatively, the AP may acquire information about the periodic interference (e.g., its timing, strength, etc.) based on information obtained from one or more other devices (i.e., STAs) in the WLAN.

In yet other embodiments, the presence and timing of the periodic interference may also be acquired from an information exchange between a node in the interfering system (e.g., from a 3GPP LTE network node) and the WLAN AP. This may be the typical approach if the LTE network node and the WLAN AP are co-located.

In still other alternative embodiments, the WLAN AP scans adjacent channels for interferers and detects the periodic interference (e.g., from an LTE system).

In another aspect of some but not necessarily all embodiments consistent with the invention, the AP informs connected devices of the reason why a certain schedule is being used (i.e., that interference prevents using the channel at some instants of time), whereas in other embodiments no reason for a particular scheduling is provided by the AP to the devices. Information about why a certain schedule is being used may not be particularly useful in embodiments that are entirely controlled by the AP, but in embodiments that distribute control of channel access among the various stations, a station may be able to utilize such information in its channel access control logic.

These and other aspects are described further in the following.

As mentioned earlier, to ease the description and facilitate an understanding of the various aspects by employing well-known terminology, the description is made under the assumption that the periodic interference is due the operation of a 3GPP LTE TDD system. However, the various principles and ideas presented here are applicable to the mitigation of periodic interference in general. Consequently, the example involving 3GPP LTE TDD can be seen as a special case in which the period of the interference corresponds to the frame duration in the LTE system and in which the on-time of the interference corresponds to the transmissions performed within the LTE system (e.g., interfering DL transmissions from an eNB to a UE, and/or interfering UL transmissions from a UE to an eNB).

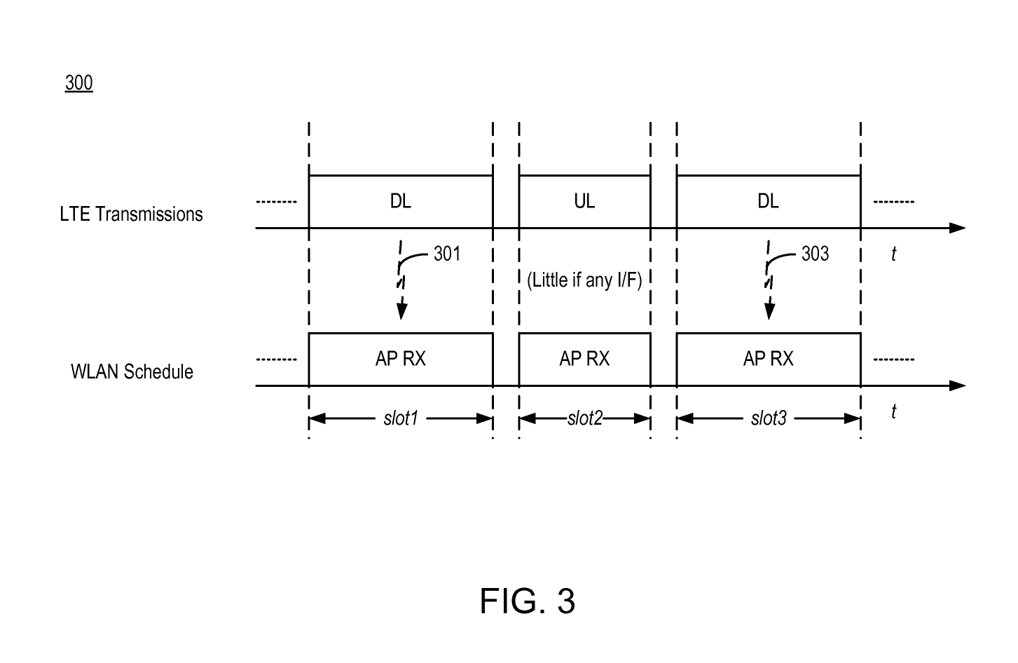

To further illustrate the problem, reference is again made to FIG. 1, in which an AP 103 in an exemplary WLAN deployment experiences interference from an eNB 111 in a neighboring LTE system. A periodic interference pattern 300 corresponding to this situation and ascertainable by the AP 103 is illustrated in FIG. 3. To simplify the figure, only the AP's receive operations are shown; it will be recognized the AP 103 also transmits, but these occurrences are not shown.

Three slots are shown: slot1, slot2, and slot3. The LTE system's frame structure is such that DL transmissions are performed during slot1 and slot3, and an UL transmission is performed during slot2. The reader will understand that this is a repeating pattern, of which only three slots are shown. Given the exemplary arrangement depicted in FIG. 1, the inventors have observed that, with respect to the AP 103, interfering signals 301, 303 from the eNB 111 occur only in slot1 and slot3; there is little, if any, such interference during slot2.

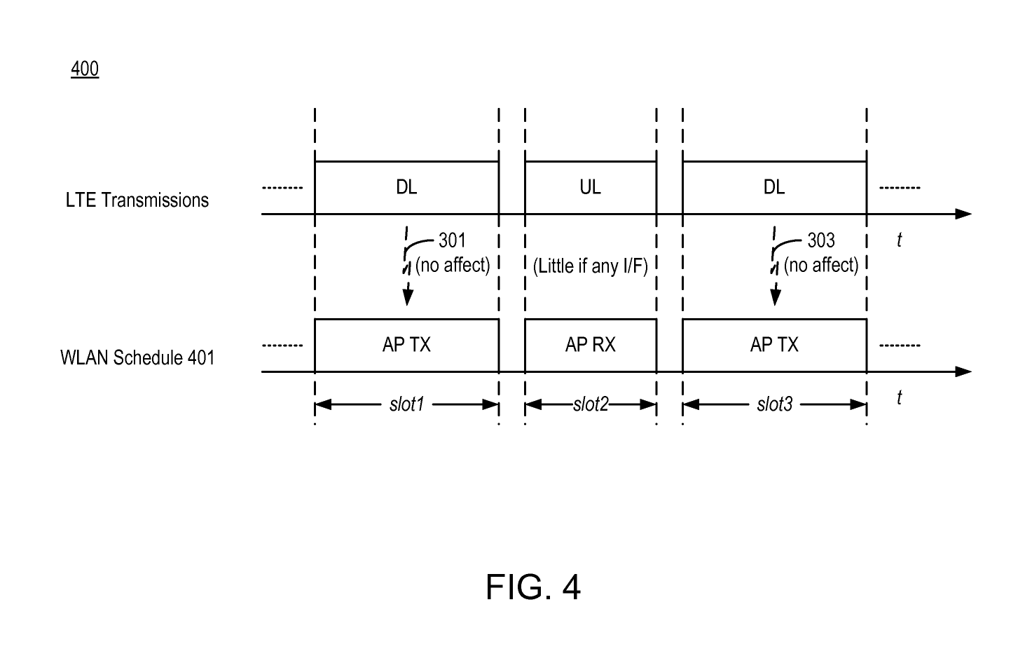

An aspect of embodiments consistent with the invention therefore has the AP 103 acquiring information about the periodic interference pattern 300. Based on the periodic interference pattern 300, and as illustrated in FIG. 4 by the modified interference pattern 400, the AP 103 creates a WLAN schedule 401 in which the AP 103 (i.e., the device in this example whose ability to receive a packet will be disturbed by one or more future occurrences of the periodic transmissions 301, 303) performs packet transmission and no reception during the one or more future occurrences of the detected periodic transmissions. By operating in this manner, the periodic DL transmissions 301, 303 of the eNB 111 will not disturb reception at the AP 103 because the AP 103 is never receiving when the periodic transmissions 301, 303 are present. Stated another way, the AP 103 aligns its operation to match up with the timing of the periodic transmissions 301, 303 (which in this example corresponds to the DL/UL timing of the LTE system) in such a way that it avoids reception whenever it is predicted that the interference will occur.

This principle of aligning the interference-affected device's operation such that it only transmits when the interference is predicted to be present can be applied in a number of differing embodiments. For example, in embodiments in which the AP is configured to include a point coordination function (PCF—a polling-based centralized channel access mechanism that is known in the art and defined by IEEE 802.11 specifications), the AP aligns to the LTE transmissions by establishing a contention free period (CFP) during which the channel is coordinated by the AP. During the CFP, the transmission is controlled by the AP such that the AP polls the individual devices (e.g., STAs). In this way, the AP can ensure that the transmissions from and to the AP are performed during suitable times (i.e., the AP transmitting during times of predicted interference, and receiving during predicted non-occurrences of the interference).

In some but not necessarily all embodiments consistent with the invention, the AP, in deriving the WLAN scheduling, takes into account not only when the interfering periodic transmissions are predicted to occur, but also the individual magnitudes of each of the other devices' received power. In such embodiments, for devices whose signals are received with high power, the AP may decide to schedule these even in the presence of an interfering transmission if it is determined that the associated SIR will still be sufficient for successful packet reception. Devices whose signals are received with low power, on the other hand, are scheduled to be received only during predicted nonoccurrences of the periodic interference, as described above.

Some WLAN deployments, such as those that conform to IEEE 802.11 standards, employ link adaptation wherein the modulation and coding scheme (MCS) employed is varied depending on packet reception conditions. This means that a device (e.g., STA) may ordinarily switch to a less robust MCS in response to detecting that several packets with one MCS has been successfully received by the AP. In another aspect employed in some but not necessarily all embodiments, an AP that knows that a robust MCS is needed to handle the LTE interference may control the other device in a way that limits what MCS the other device is allowed to use.

It is noted that the affected device (e.g., the AP 103 in FIG. 1) only being able to receive signals during times when it is predicted that there will not be any periodic interference puts limiting constraints on channel access. However, the times during which the channel can be accessed are typically characterized by higher (i.e., more favorable) carrier-to-interference (C/I) levels, making it possible to employ higher data rates. In some but not necessarily all embodiments consistent with the invention, the AP, in deriving the WLAN scheduling, takes this characteristic into account by producing schedules in which devices having time critical but low rate data are scheduled to direct robust MCS transmissions to the interference-affected device (e.g., the AP) at times that include predicted occurrences of interference, but in which high data rate users having more relaxed time requirements are scheduled to transmit to the interference-affected device at times that are predicted to not coincide with the periodic interference. In this way both high aggregate data rate and time requirements can be supported within the WLAN.

In future generations of IEEE 802.11-compliant deployments, it may be so that a more scheduled channel access strategy is used (e.g., a TDD scheme may be employed similar to what is used in 3GPP LTE systems). With this in mind, in some but not necessarily all embodiments consistent with the invention, an AP in a TDD-based WLAN deployment may derive a transmission/reception schedule that aligns the WLAN's TDD frame structure to that of the interfering system's TDD frame structure. One example would be to use the same UL/DL ratio as well as the same frame duration as is being used in the interfering system. If the frame duration of the WLAN system differs from that of the interfering system, alignment can be achieved by having the DL frames between the two systems align as much as possible.

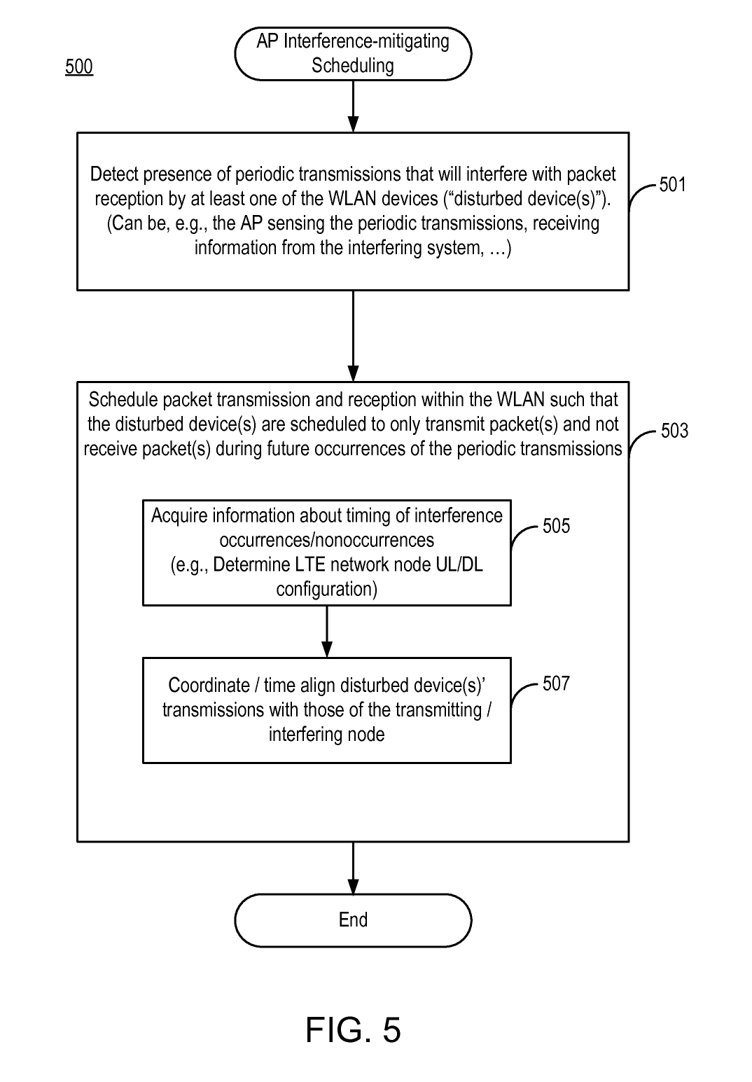

To further illustrate aspects of embodiments consistent with the invention, FIG. 5 is, in one respect, a flow chart of steps/processes performed by circuitry in accordance with some but not necessarily all exemplary embodiments of the invention. In another respect, FIG. 5 can be considered to depict exemplary means 500 comprising the various illustrated circuitry (e.g., hard-wired and/or suitably programmed processor) configured to perform the described functions.

As shown in FIG. 5, an exemplary embodiment involves operation of a wireless access point device that schedules packet transmission and reception by a set of devices in a wireless local area network. Consistent with an earlier part of this description, the term “set of devices” includes the access point device and one or more other devices.

The access point scheduling operation involves detecting the presence of periodic transmissions on a first carrier frequency, wherein one or more future occurrences of the periodic transmissions will interfere with reception of a packet by a first device of the set of devices (i.e., by the AP and/or one or more of the stations) (step 501). For example, the interference may be coming from any sort of LTE transmitting node (e.g., a network node/eNodeB or a UE/Mobile equipment, sensor, modem, smartphone, . . . ) operating on an adjacent channel. For instance, if the AP is operating in the 2.4 GHz ISM band, the interference could be coming from a closely located LTE transmitting node operating in the 3GPP Band 40. In another example, typically applicable, but not limited to the 5 GHz ISM band, the periodic interference could be coming from license-assisted LTE transmissions on the same or adjacent 5 GHz ISM band channels.

Detection of the periodic interference can be performed in any number of ways. For example, the AP may determine the potential presence or non-presence of periodic interference by determining the position (e.g., country) it is operating in. For instance, 3GPP Band 40 is presently used in only a subset of all countries in the world, and licensed assisted LTE may also be allowed in a restricted set of countries. If the location of the AP indicates that there is a potential risk for interference from a nearby 3GPP LTE system, the AP scans for LTE signals in the adjacent frequency band. This may be done in several ways such as, without limitation, using an incorporated LTE modem doing regular cell search. Of course, some embodiments may entirely skip the initial detection of the potential for interference, and instead proceed directly to having the AP scan for periodic interfering signals.

In another embodiment where the LTE NW node and the WLAN AP are co-located, the determination can be accomplished by exchanging information between the WLAN deployment and the LTE system. This information exchange can be performed over a backhaul or other communication path.

Packet transmission and reception are then scheduled within the WLAN such that the one or more devices whose reception of packets will be disturbed by future occurrences of the periodic interference (“disturbed device(s)”) are scheduled to perform packet transmission and no reception during the future occurrences of the detected periodic transmissions (step 503).

In order to perform scheduling, the AP needs to acquire information enabling it to predict when the interfering transmissions will and will not occur (step 505). For example, when the interference emanates from an LTE system, the AP determines the network node (e.g., eNodeB or UE, depending on source of interference) UL/DL configuration. This can be done in several ways. In one embodiment, the AP is equipped with LTE modem and, if the interference comes from an eNodeB, uses this to read the LTE system's broadcast information (MIB/SIB) giving the UL/DL configuration and timing (known since once the primary/secondary synchronization signals (PSS/SSS) are detected and the MIB/SIB is read, the AP knows the LTE UL/DL timing and configuration). In another embodiment, the AP determines the UL/DL configuration by RSSI scanning and then analyzing the measured RSSI to detect its variation over time. As is well known in the art, LTE UL and DL transmissions have different RSSI profiles. This characteristic can be utilized here by comparing the measured RSSI profile with known profiles to detect instances of UL transmissions and/or instances of DL transmissions.

In another alternative embodiment, when the LTE transmitting/interfering node (e.g., eNodeB or UE) and the AP are co-located, timing information is exchanged over the backhaul connection.

Having acquired information about the timing of the interfering transmissions, the AP then coordinates/time aligns the disturbed device(s)′ transmissions to coincide with the LTE node's interfering transmissions (step 507).

In another aspect relating to step 503 (i.e., scheduling), the AP may, in some but not necessarily all embodiments, treat all devices in a similar way to ease the scheduling overhead. The AP may then generate a table that organizes information about when transmissions from and to the AP are possible during the interfering system's (e.g., LTE system's) respective DL and UL transmissions.

One exemplary table consistent with these embodiments is shown in the following Table 1:

TABLE 1

| Transmission | LTE DL transmission | LTE UL transmission |
|---|---|---|
| AP [symbol] STA | OK/Not OK | OK/Not OK |
| STA [symbol] AP | OK/Not OK | OK/Not OK |

In the above table, “OK” means that the indicated transmission can take place without being disturbed by the periodic interference; “Not OK” means it cannot. Of course, alternative embodiments can employ any form of data structure, or no data structure (e.g., program state), to organize this information.

As an example, suppose that transmissions to and from the AP are possible (i.e., not disturbed by periodic interference) during a neighboring LTE system's UL transmissions but not during its DL transmissions. Since, in this example, the interference is disturbing both the AP and the device (i.e., the STA), the AP would accordingly schedule all traffic, both to and from the AP, to occur during the LTE system's UL periods and make sure that no transmissions were scheduled during the DL periods.

As another example, suppose that transmission from the AP is possible (i.e., the STA can receive a transmission) during the interfering system's DL transmissions but not during its UL transmissions, whereas undisturbed transmission to the AP is possible during the interfering system's UL transmissions but not during its DL transmissions. This would mean that the AP would schedule transmission from itself during the interfering system's DL transmission periods, and transmissions from the devices (STAs) would be scheduled to occur during the interfering system's UL transmission periods. An example in which this scenario can happen is when the AP is collocated with the interfering system's (e.g., LTE system's) base station (BS) whereas the other device (STA) is located close to, or even collocated with, an interfering UE.

As yet another example, suppose that transmission from the AP (and undisturbed reception by the STA) is possible during the interfering system's UL transmission but not during its DL transmissions, whereas undisturbed transmission to the AP is possible during the interfering system's DL transmissions but not during its UL transmissions. This would mean that the AP would schedule transmission from itself to the device (STA) during the interfering system's UL periods, and transmissions from the disturbed device (STA) during the interfering system's DL periods (i.e., the STA's transmissions would be aligned with the occurrences of periodic interference). An example in which this scenario can happen is when the AP happens to be close to an interfering UE, whereas the other device (STA) happens to be close to the interfering system's base station.

The above examples depict deployments in which the non-AP devices (i.e., STAs) experience similar interference conditions. As a consequence, the scheduling for the “STA” depicted in the above examples can be applied to all STA's in the deployment. In situations when the non-AP devices (STAs) experience very different interference conditions from one another, a restrictive approach can be applied in which the transmission to and from the least favorable STA governs how the schedule will be constructed.

However, in deployments having many non-AP devices (STAs), scheduling all STAs based on the worst-case device may be too restrictive. Therefore, in another embodiment, the AP treats the different STAs individually. The information upon which a schedule can be constructed for the case of two non-AP devices (two STAs) is illustrated in Table 2, below. As before, it will be recognized that alternative embodiments can employ any form of data structure, or no data structure (e.g., program state), to organize this information.

TABLE 2

| Transmission | LTE DL transmission | LTE UL transmission |
|---|---|---|
| AP [symbol] STA1 | OK/Not OK | OK/Not OK |
| STA1 [symbol] AP | OK/Not OK | OK/Not OK |
| AP [symbol] STA2 | OK/Not OK | OK/Not OK |
| STA2 [symbol] AP | OK/Not OK | OK/Not OK |

The principles for forming the schedule are the same as those described above (i.e., scheduling a disturbed device to transmit rather than receive during occurrences of periodic interference).

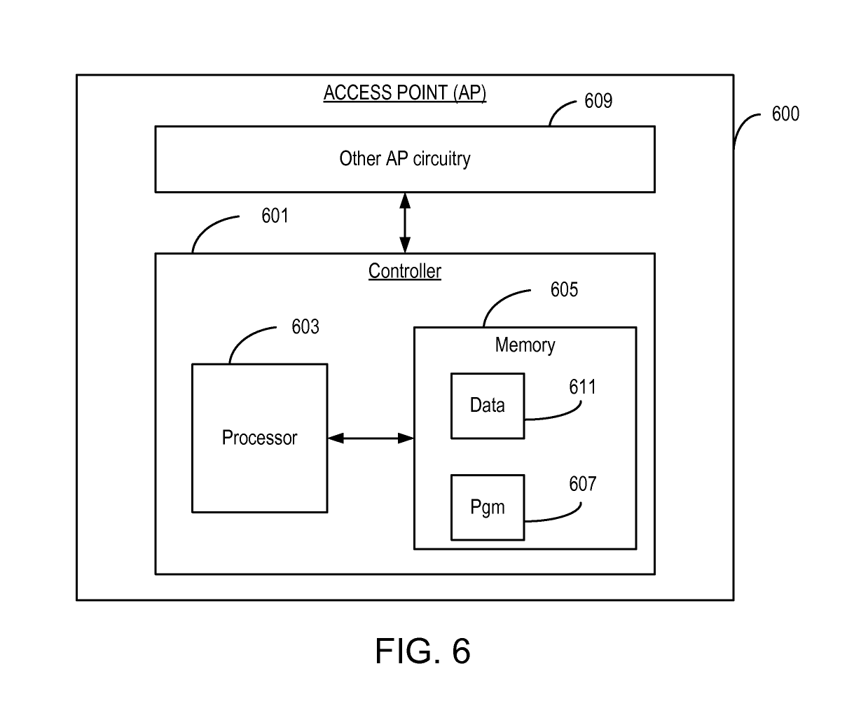

FIG. 6 is a block diagram of an exemplary access point 600 of a WLAN wherein the access point 600 comprises a controller 601 that is circuitry configured to carry out, in addition to typical AP functionality, any one or any combination of the aspects described in connection with any one or combination of FIGS. 4 and 5 above. Such circuitry could, for example, be entirely hard-wired circuitry (e.g., one or more ASICs). Depicted in the exemplary embodiment of FIG. 6, however, is programmable circuitry, comprising a processor 603 coupled to one or more memory devices 605 (e.g., Random Access Memory, Magnetic Disc Drives, Optical Disk Drives, Read Only Memory, etc.). The memory device(s) 605 store program means 607 (e.g., a set of processor instructions) configured to cause the processor 603 to control other node circuitry/hardware components 609 so as to carry out any of the functions described above. The memory 605 may also store data 611 representing various constant and variable parameters as may be received, generated, and/or otherwise needed by the processor 603 when carrying out its functions such as those specified by the program means 607.

Embodiments consistent with the invention provide advantages over conventional interference mitigation techniques in that, in the case of periodic interference, the interference can be mitigated and in some cases even avoided. Consequently, improved WLAN performance and spectral efficiency is achieved.

The invention has been described with reference to particular embodiments. However, it will be readily apparent to those skilled in the art that it is possible to embody the invention in specific forms other than those of the embodiment described above.

Accordingly, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of operating a wireless access point device that schedules packet transmission and reception by a set of devices in a wireless local area network, wherein the set of devices includes the access point device and one or more other devices, the method comprising:
detecting the presence of periodic transmissions on a first carrier frequency from a first transmitter not operating in the wireless local area network, wherein one or more future occurrences of the periodic transmissions will interfere with reception of a packet by a first device of the set of devices; and
scheduling packet transmission and reception within the wireless local area network such that the first device performs packet transmission and no reception during the one or more future occurrences of the detected periodic transmissions.

2. The method of claim 1, wherein:
the wireless local area network operates in an unlicensed band of a radio frequency spectrum; and
the first carrier frequency is a neighboring carrier frequency of the unlicensed band.

3. The method of claim 1, wherein:
the first transmitter is a transmitter operating in a cellular communication system;
the wireless local area network operates in an unlicensed band of a radio frequency spectrum; and
the periodic transmissions on the first carrier frequency are licensed assisted transmissions in the unlicensed band of the radio frequency spectrum by the first transmitter.

4. The method of claim 1, wherein:
the first transmitter is a transmitter operating in a cellular communication system;
the periodic transmissions on the first carrier frequency are time division duplex uplink or downlink transmissions of the first transmitter; and
detecting the presence of periodic transmissions on the first carrier frequency comprises communicating information from a node of the cellular communication system to the wireless access point device.

5. The method of claim 1, wherein:
the first transmitter is a transmitter operating in a cellular communication system;
the periodic transmissions on the first carrier frequency are time division duplex uplink or downlink transmissions of the first transmitter; and
detecting the presence of periodic transmissions on the first carrier frequency comprises the wireless access point device performing a cell scan and identifying radio access technology associated with neighboring carriers.

6. The method of claim 1, wherein the first device uses the first carrier frequency to receive the packet.

7. The method of claim 1, wherein:
the first device uses a second carrier frequency to receive the packet; and
the second carrier frequency is adjacent to the first carrier frequency.

8. The method of claim 1, wherein:
the wireless local area network operates in a first frequency band of a radio frequency spectrum; and
the first carrier frequency is in a second frequency band that is adjacent to the first frequency band.

9. The method of claim 1, wherein scheduling packet transmission and reception within the wireless local area network such that the first device performs packet transmission and no reception during the one or more future occurrences of the detected periodic transmissions comprises establishing one or more contention free periods for medium access within the wireless local area network.

10. The method of claim 1, comprising:
ascertaining that the one or more future occurrences of the periodic transmissions will not interfere with reception of a packet by a second device of the set of devices; and
scheduling packet transmission and reception within the wireless local area network such that the second device performs reception during the one or more future occurrences of the detected periodic transmissions.

11. The method of claim 10, wherein:
the second device is configured to use any one of a plurality of modulation and coding schemes providing respective levels of robustness of communication; and
the method comprises preventing the second device from using any one of the modulation and coding schemes that does not provide a level of robustness that is higher than a threshold level of robustness.

12. The method of claim 1, wherein scheduling packet transmission and reception within the wireless local area network is, in part, based on a data rate and delivery time requirement of packet transmissions to the first device and further on the data rate and delivery time requirements of one or more other devices in the wireless local area network such that devices having time critical data at a low data rate receive data during the one or more future occurrences of the detected periodic transmissions, and such that other ones of the devices having less time critical data at a higher data rate receive data during future non-occurrences of the detected periodic transmissions.

13. The method of claim 1, comprising:
ascertaining that one or more future occurrences of the periodic transmissions will interfere with reception of a packet by a second device of the set of devices; and
scheduling packet transmission and reception within the wireless local area network such that the second device performs packet transmission and no reception during the one or more future occurrences of the detected periodic transmissions.

14. An apparatus for operating a wireless access point device that schedules packet transmission and reception by a set of devices in a wireless local area network, wherein the set of devices includes the access point device and one or more other devices, the apparatus comprising:
circuitry configured to detect the presence of periodic transmissions on a first carrier frequency from a first transmitter not operating in the wireless local area network, wherein one or more future occurrences of the periodic transmissions will interfere with reception of a packet by a first device of the set of devices; and
circuitry configured to schedule packet transmission and reception within the wireless local area network such that the first device performs packet transmission and no reception during the one or more future occurrences of the detected periodic transmissions.

15. The apparatus of claim 14, wherein:
the first transmitter is a transmitter operating in a cellular communication system;
the periodic transmissions on the first carrier frequency are time division duplex uplink or downlink transmissions of the first transmitter; and
the circuitry configured to detect the presence of periodic transmissions on the first carrier frequency comprises circuitry configured to perform a cell scan and to identify therefrom radio access technology associated with neighboring carriers.

16. The apparatus of claim 14, wherein the circuitry configured to schedule packet transmission and reception within the wireless local area network such that the first device performs packet transmission and no reception during the one or more future occurrences of the detected periodic transmissions comprises circuitry configured to establish one or more contention free periods for medium access within the wireless local area network.

17. The apparatus of claim 14, comprising:
circuitry configured to ascertain that the one or more future occurrences of the periodic transmissions will not interfere with reception of a packet by a second device of the set of devices; and
circuitry configured to schedule packet transmission and reception within the wireless local area network such that the second device performs reception during the one or more future occurrences of the detected periodic transmissions.

18. The apparatus of claim 17, wherein:
the second device is configured to use any one of a plurality of modulation and coding schemes providing respective levels of robustness of communication; and
the apparatus comprises circuitry configured to prevent the second device from using any one of the modulation and coding schemes that does not provide a level of robustness that is higher than a threshold level of robustness.

19. The apparatus of claim 14, wherein the circuitry configured to schedule packet transmission and reception within the wireless local area network is, in part, based on a data rate and delivery time requirement of packet transmissions to the first device and further on the data rate and delivery time requirements of one or more other devices in the wireless local area network such that devices having time critical data at a low data rate receive data during the one or more future occurrences of the detected periodic transmissions, and such that other ones of the devices having less time critical data at a higher data rate receive data during future non-occurrences of the detected periodic transmissions.

20. The apparatus of claim 14, comprising:
circuitry configured to ascertain that one or more future occurrences of the periodic transmissions will interfere with reception of a packet by a second device of the set of devices; and
circuitry configured to schedule packet transmission and reception within the wireless local area network such that the second device performs packet transmission and no reception during the one or more future occurrences of the detected periodic transmissions.
